(19) United States
(12) Patent Application Publication
(10) Pub. No.: US 2026/0336500 A1
(43) Pub. Date: Oct. 29, 2026

(54) CARGO LIFT FOR TRAILERS OR PICKUP TRUCK BEDS AND A METHOD OF LOADING LARGE OBJECTS INTO A TRAILER OR A PICKUP TRUCK BED

(71) Applicant: Brian Roark, Hickory Creek, TX (US)

(72) Inventor: Brian Roark, Hickory Creek, TX (US)

(21) Appl. No.: 19/186,893

(22) Filed: Apr. 23, 2025

(51) Int. Cl. B60P 1/64; B60P 7/13; B65G 67/04

(52) U.S. Cl. CPC B60P 1/6445; B65G 67/04; B60P 7/13

(57) ABSTRACT

A cargo lift for trailers and pickup truck beds includes a frame, a platform, and four lift assemblies. The frame includes a front frame piece. A pair of side frame pieces extends perpendicularly from the front frame piece. A rear frame piece extends perpendicularly between the side frame pieces. The rear frame piece includes a U-shaped opening. A bottom frame piece extends perpendicularly between lower portions of the front frame piece and the rear frame piece. The platform is coupled to the bottom frame piece to support objects. Each of the lift assemblies is coupled to the frame and designed to raise and lower the frame. Each of the lift assemblies is positioned on the frame such that the lift assemblies are designed to extend outside of and parallel to side walls of a bed of a pickup truck when the frame is positioned above the bed.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to cargo lift devices and more particularly pertains to a new cargo lift for trailers and pickup truck beds. It is common to transport large objects, such as motorcycles, in the beds of pickup trucks. However, due to the excessive weight, it is very difficult to get such objects into the bed. Ramps and similar devices can be used, but this still requires substantial effort and possible risk of injury to the person loading the object. The new cargo lift allows the user to load the object onto the cargo lift at ground level, then use the cargo lift to raise the object up above the truck bed, move the truck bed under the cargo lift, and then lower the object into the truck bed with reduced physical effort and increased safety. It should be understood that the any reference to a “truck” or “pickup truck” as used herein also includes any other similar or related vehicle or mechanism, such as a trailer or flatbed.

### (2) Description of Related Art including information disclosed under 37 CFR 1.97 and 1.98.

The prior art relates to cargo lift devices for trucks, campers, and heavy freight. The prior art, as best understood, does not disclose a cargo lift that has a platform mounted on frame with attached lift legs to lift up a heavy object, which frame is wide enough to allow a pickup truck bed to be driven under the frame with the lift legs on either side, and which frame and platform are lowerable onto the truck bed and securable to the truck bed for transport.

### (h) BRIEF SUMMARY OF THE INVENTION

An embodiment of the disclosure meets the needs presented above in a cargo lift generally comprising a frame, a platform, and four lift assemblies. The frame is rectangular. The frame is detachably couplable to anchors in a bed or frame of a pickup truck. The frame includes a front frame piece. A pair of side frame pieces is coupled to and extends perpendicularly from the front frame piece. A rear frame piece is coupled to and extends perpendicularly between the side frame pieces. The rear frame piece includes a U-shaped opening designed for movement of objects into and out of the frame. A bottom frame piece is coupled to a lower portion of the front frame piece and a lower portion of the rear frame piece in alignment with the U-shaped opening. The bottom frame piece extends perpendicularly between the front frame piece and the rear frame piece. The platform is coupled to the bottom frame piece. The platform is designed to support objects thereon. Each of the lift assemblies is coupled to the frame at a respective end of each of the side frame pieces. Each of the lift assemblies is designed to selectively raise and lower the frame and the platform between an elevated position above side walls of the bed of a pickup truck and a lowered position on a ground surface. Each of the lift assemblies is positioned on the frame such that the lift assemblies are designed to extend outside of and parallel to the side walls of the bed of the pickup truck when the frame is positioned above the bed of the pickup truck.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a cargo lift according to an embodiment of the disclosure.

FIG. 2 is a top view of an embodiment of the disclosure.

FIG. 3 is a front view of an embodiment of the disclosure.

FIG. 4 is a side view of an embodiment of the disclosure in use.

FIG. 5 is a side view of an embodiment of the disclosure in use.

FIG. 6 is a side view of an embodiment of the disclosure in use.

FIG. 7 is a side view of an embodiment of the disclosure in use.

FIG. 8 is a side view of an embodiment of the disclosure in use.

FIG. 9 is a side view of an alternative embodiment of the disclosure in use.

FIG. 10 is a side view of the alternative embodiment of the disclosure in use.

### (J) DETAILED DESCRIPTION OF THE INVENTION

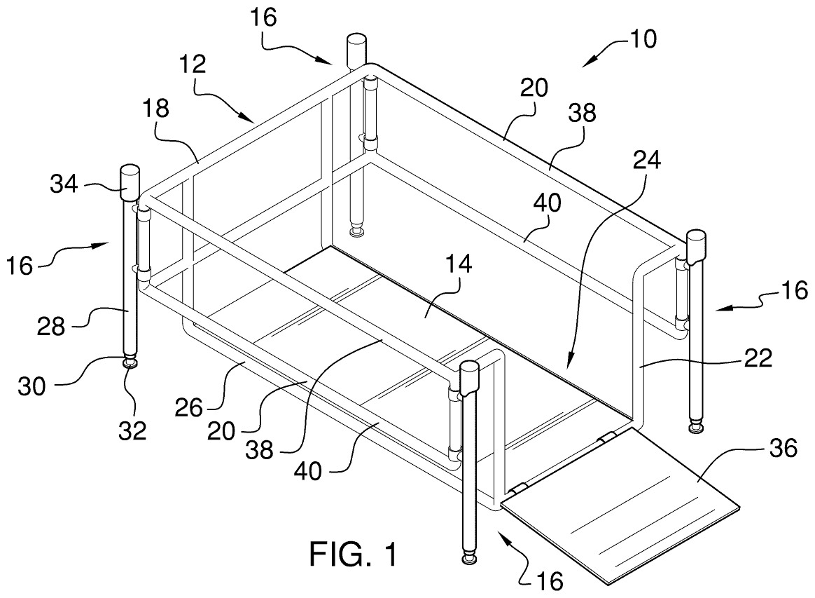

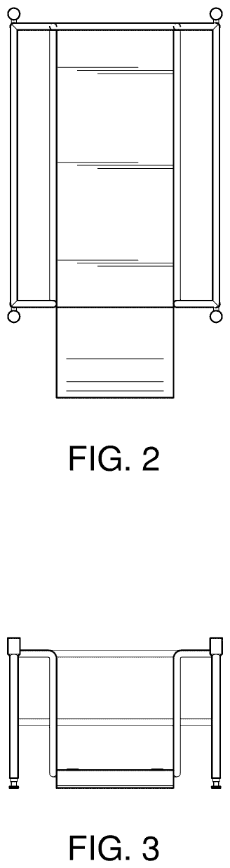

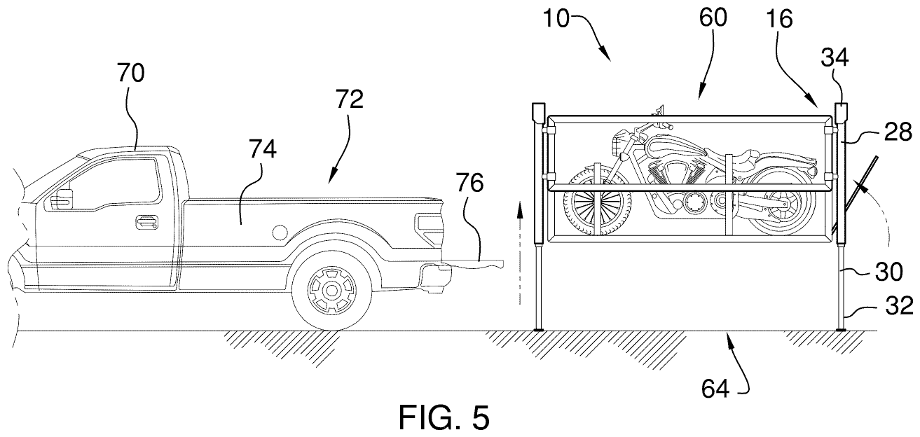

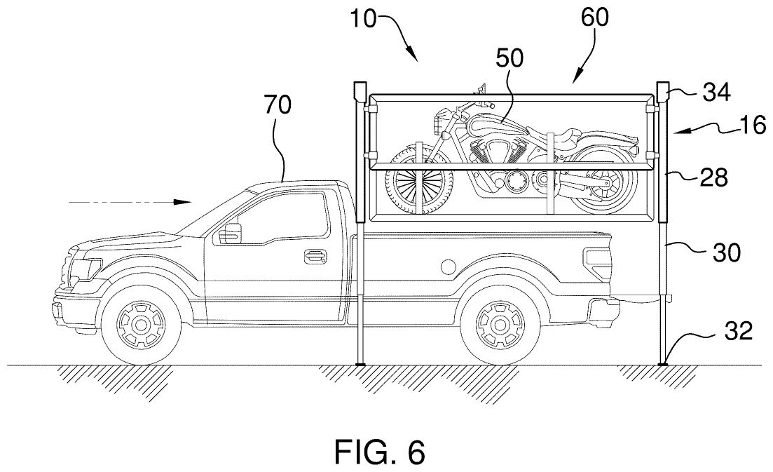

With reference now to the drawings, and in particular to FIGS. 1 through 10 thereof, a new cargo lift embodying the principles and concepts of an embodiment of the disclosure and generally designated by the reference numeral 10 will be described.

As best illustrated in FIGS. 1 through 10, the cargo lift 10 generally comprises a frame 12, a platform 14, and four lift assemblies 16. The frame 12 is rectangular. The frame 12 is detachably couplable to anchors (not shown) in a bed 72 of a pickup truck 70. In one possible embodiment, the frame 12 can be detachably coupled to frame mounts (not shown) of the pickup truck 70. The frame 12 includes a front frame piece 18. A pair of side frame pieces 20 is coupled to and extends perpendicularly from the front frame piece 18. A rear frame piece 22 is coupled to and extends perpendicularly between the side frame pieces 20. The rear frame piece 22 includes a U-shaped opening 24 designed for movement of objects into and out of the frame 12. A bottom frame piece 26 is coupled to a lower portion of the front frame piece 18 and a lower portion of the rear frame piece 22 in alignment with the U-shaped opening 24. The bottom frame piece 26 extends perpendicularly between the front frame piece 18 and the rear frame piece 22. The platform 14 is coupled to the bottom frame piece 26. The platform 14 is designed to support objects thereon. Each of the lift assemblies 16 is coupled to the frame 12 at a respective end of each of the side frame pieces 20. Each of the lift assemblies 16 is designed to selectively raise and lower the frame 12 and the platform 14 between an elevated position 60 above side walls 74 of the bed 72 of a pickup truck 70 and a lowered position 62 on a ground surface. Each of the lift assemblies 16 is positioned on the frame 12 such that the lift assemblies 16 are designed to extend outside of and parallel to the side walls 74 of the bed 72 of the pickup truck 70 when the frame 12 is positioned above the bed 72 of the pickup truck 70.

In the exemplary embodiment, each of the lift assemblies 16 includes a housing 28 coupled to the frame 12. A leg 30 is positioned in the housing 28 in a telescoping manner. The leg 30 can be a single rod or a plurality of telescoping rods. A foot 32 is attached to an end of the leg 30. A drive 34 is mounted to the housing 28. The drive 34 is coupled to the leg 30 to selectively extend the leg 30 out of the housing 28 and retract the leg 30 into the housing 28 to selectively raise and lower the frame 12 and the platform 14. The drive 34 can be electromechanical or pneumatic or a combination thereof. An electric source and/or pneumatic source is connected to the drives 34 in a manner well known in the power lifting arts, and thus is not shown in any detail. In one possible embodiment, each drive 34 could have its own power source mounted in the housing 28. While only four lift assemblies 16 are shown at the corners of the frame 12 in the exemplary embodiment, more lift assemblies 16 could be included and attached at different locations on the frame 12.

In the exemplary embodiment in FIG. 1, the cargo lift 10 further includes a ramp 36 that is pivotably connected to the rear frame piece 22 at the U-shaped opening 24 and aligned with the platform 14. The ramp 36 is selectively pivotable into a storage position overlapping the platform 14 and into a use position projecting out of the frame 12 for movement of objects onto the platform 14.

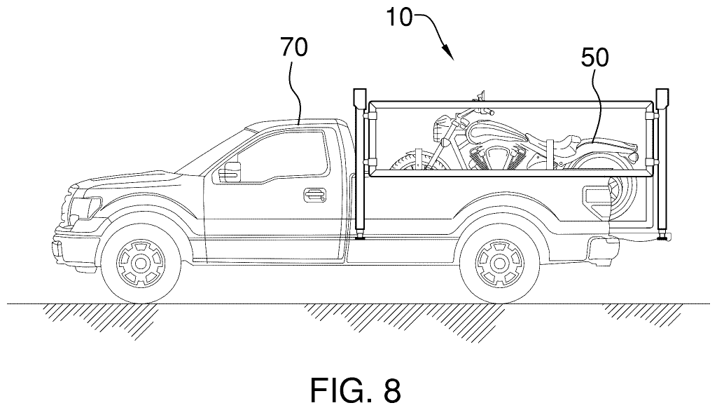

In the exemplary embodiment in FIG. 1, each of the side frame pieces 20 includes an upper side rail 38 and a lower side rail 40 positioned parallel to the upper side rail 38. The lower side rail 40 is designed to be positioned at an upper edge of a respective one of the side walls 74 of the pickup truck 70 when the frame 12 is positioned above the bed 72 of the pickup truck 70, as shown in FIG. 8. The lower side rails 40 could be positioned to rest on top of the side walls 74 to support the frame 12 or be positioned outside of the side walls 74. As shown in FIG. 1, each of the front frame piece 18 and the rear frame piece 22 extends below the lower side rail 40 of each of the side frame pieces 20 to support the bottom frame piece 26 and the platform 14 a distance below the lower side rail 40 of each of the side frame pieces 20 and at a floor of the bed 72 of the pickup truck 70 when the frame 12 is positioned above the bed 72 of the pickup truck 70. The frame 12 could be designed such that the bottom frame piece 26 rests on the floor of the bed 72 of the pickup truck 70, or is positioned a distance above the floor, with the frame 12 being supported on the side walls 74 of the bed 72 of the pickup truck 70 on the front frame piece 18 and/or the side frame pieces 20.

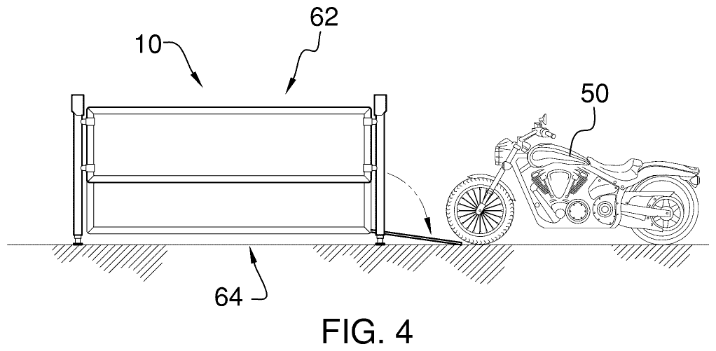

In the exemplary embodiment in FIGS. 4, the housing 28 of each of the lift assemblies 16 extends from the upper side rail 38 of each of the side frame pieces 20 to a position even with the bottom frame piece 26. Each of the side frame pieces 20 has a length such that the frame 12 extends beyond a length of the bed 72 of the pickup truck 70 and onto an open tailgate 76 of the pickup truck 70 when the frame 12 is positioned above the bed 72 of the pickup truck 70, as best seen in FIG. 8. The frame 12 includes elongated pipes, such as metal pipes that are tubular or rectangular, integrally joined together, though in another possible embodiment the frame 12 could include solid or wire panels.

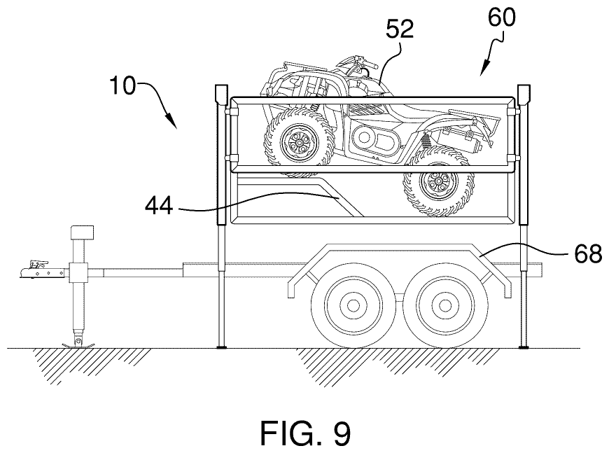

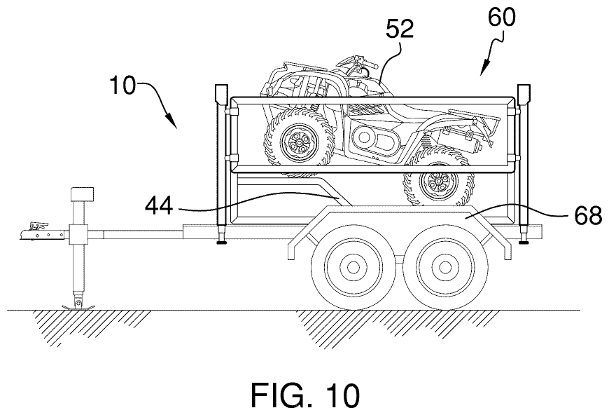

It should be noted that FIG. 1 shows only one exemplary embodiment of the frame 12, and the exact construction of the frame 12 could be varied for different positioning and reinforcement. For example, a gate or similar structure could be placed at the U-shaped opening 24 in the rear frame piece 22. Also in that regard, FIGS. 9 and 10 show an alternative design in which the frame 12 is somewhat larger and sized for placement on a trailer 68. In this embodiment, the bottom frame piece 26 includes an angled raised shelf 44 to selectively position a first portion of an object higher than a second portion of the object, in this case an all-terrain vehicle 52.

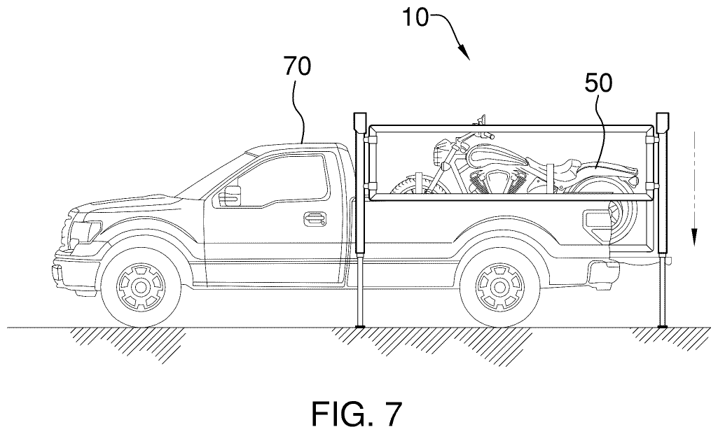

The cargo lift 10 can be used to load large objects into the bed 72 of the pickup truck 70, or possibly another type of transport. In the exemplary embodiments, the large objects are vehicles, specifically a motorcycle 50 and the all-terrain vehicle 52, though obviously other large objects, or even small objects, can be loaded using the cargo lift 10. However, the primary use is for large objects that cannot easily be placed in the bed 72 of the pickup truck 70. FIGS. 4 through 8 show an exemplary embodiment of the cargo lift 10 being used to load the motorcycle 50, whereas FIGS. 9 and 10 show the alternative design of the cargo lift 10 being used to load the all-terrain vehicle 52 on the trailer 68, as mentioned above. As shown in FIG. 4, the user first moves the motorcycle 50 through the U-shaped opening 24 in the rear frame piece 22 and onto the platform 14. In the exemplary embodiment in FIG. 4, the ramp 36 has been pivoted out to facilitate rolling the motorcycle 50 onto the platform 14. The user then activates the lift assemblies 16 and elevates the frame 12 and the platform 14 to the elevated position 60. The activation of the lift assemblies 16 can be done in a known manner, such as by a remote control or by a control panel mounted on the frame 12 and wired to the lift assemblies 16. This design is not shown in any detail in the figures as it is well known in the power lifting arts. The user then drives the pickup truck 70 in reverse and positions the bed 72 of the pickup truck 70 under the frame 12 and between the lift assemblies 16. The user then activates the lift assemblies 16 and lowers the frame 12 and the platform 14 until the frame 12 is supported on the pickup truck 70, as shown in FIG. 7, and the lift assemblies 16 are suspended from a support surface 64, such as the ground or a floor, as shown in FIG. 8. In the exemplary embodiment, the user elevates the frame 12 by extending the legs 30 out of the housing 28, and also lowers the frame 12 by retracting the legs into the housing 28. The legs 30 can be retracted all the way into the housing 28 as shown in FIG. 8 due to the telescoping design of the legs 30. The user then detachably secures the frame 12 to anchors (not shown) of the bed 72 of the pickup truck 70 or frame mounts (not shown). The anchors are usually built into the bed 72 as part of the pickup truck 70, and the user can use straps (not shown) or similar connectors to detachably connect the frame 12 to the anchors. The user can connect the straps to essentially any portion of the frame 12, such as the bottom frame piece 26, the side frame pieces 20, and/or the front frame piece 18. The user can also secure the motorcycle 50, or whatever object, to the frame 12 in a known manner. Once the legs 30 are sufficiently retracted, the user can then drive the pickup truck 70 or the trailer 68 with the cargo lift 10 thereon to another location, at which time the user can reverse the process to unload the motorcycle 50 or all-terrain vehicle 52.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cargo lift for trailers and pickup truck beds comprising:
a frame being rectangular, said frame being detachably couplable to anchors in a bed of a trailer or pickup truck or frame mounts of a trailer or pickup truck, said frame including:
a front frame piece;
a pair of side frame pieces being coupled to and extending perpendicularly from said front frame piece;
a rear frame piece being coupled to and extending perpendicularly between said side frame pieces, said rear frame piece including a U-shaped opening being configured for movement of objects into and out of said frame;
a bottom frame piece being coupled to a lower portion of said front frame piece and a lower portion of said rear frame piece in alignment with said U-shaped opening, said bottom frame piece extending perpendicularly between said front frame piece and said rear frame piece;
a platform being coupled to said bottom frame piece, said platform being configured to support objects thereon; and
four lift assemblies, each of said lift assemblies being coupled to said frame at a respective end of each of said side frame pieces, said lift assemblies being configured to selectively raise and lower said frame and said platform between an elevated position above side walls of the bed of a trailer or pickup truck and a lowered position on a ground surface, each of said lift assemblies being positioned on said frame such that said lift assemblies are configured to extend outside of and parallel to the side walls of the bed of the trailer or pickup truck when said frame is positioned above the bed of the trailer or pickup truck.

2. The cargo lift of claim 1, wherein each of said lift assemblies includes:
a housing coupled to said frame;
a leg positioned in said housing in a telescoping manner;
a foot attached to an end of said leg; and
a drive mounted to said housing, said drive is coupled to said leg to selectively extend said leg out of said housing and retract said leg into said housing to selectively raise and lower said frame and said platform.

3. The cargo lift of claim 2, wherein further including a ramp being pivotably connected to said rear frame piece at said U-shaped opening and aligned with said platform, said ramp being selectively pivotable into a storage position overlapping said platform and into a use position projecting out of said frame for movement of objects onto said platform.

4. The cargo lift of claim 3, wherein:
each of said side frame pieces includes an upper side rail and a lower side rail positioned parallel to said upper side rail;
said lower side rail is configured to be positioned at an upper edge of a respective one of the side walls of the trailer or pickup truck when said frame is positioned above the bed of the trailer or pickup truck; and
each of said front frame piece and said rear frame piece extends below said lower side rail of each of said side frame pieces to support said bottom frame piece and said platform a distance below said lower side rail of each of said side frame pieces and at a floor of the bed of the trailer or pickup truck when said frame is positioned above the bed of the trailer or pickup truck.

5. The cargo lift of claim 4, wherein said housing of each of said lift assemblies extends from said upper side rail of each of said side frame pieces to a position even with said bottom frame piece.

6. The cargo lift of claim 5, wherein each of said side frame pieces has a length such that said frame extends to or beyond a length of the bed of the trailer or pickup truck when said frame is positioned above the bed of the trailer or pickup truck.

7. The cargo lift of claim 6, wherein said frame includes elongated pipes integrally joined together.

8. The cargo lift of claim 7, wherein said bottom frame piece includes an angled raised shelf to selectively position a first portion of an object higher than a second portion of the object.

9. The cargo lift of claim 1, wherein further including a ramp being pivotably connected to said rear frame piece at said U-shaped opening and aligned with said platform, said ramp being selectively pivotable into a storage position overlapping said platform and into a use position projecting out of said frame for movement of objects onto said platform.

10. The cargo lift of claim 1, wherein:
each of said side frame pieces includes an upper side rail and a lower side rail positioned parallel to said upper side rail;
said lower side rail is configured to be positioned at an upper edge of a respective one of the side walls of the trailer or pickup truck when said frame is positioned above the bed of the trailer or pickup truck; and
each of said front frame piece and said rear frame piece extends below said lower side rail of each of said side frame pieces to support said bottom frame piece and said platform a distance below said lower side rail of each of said side frame pieces and at a floor of the bed of the trailer or pickup truck when said frame is positioned above the bed of the trailer or pickup truck.

11. The cargo lift of claim 1, wherein each of said side frame pieces has a length such that said frame extends to or beyond a length of the bed of the trailer or pickup truck when said frame is positioned above the bed of the trailer or pickup truck.

12. The cargo lift of claim 1, wherein said frame includes elongated pipes integrally joined together.

13. The cargo lift of claim 1, wherein said bottom frame piece includes an angled raised shelf to selectively position a first portion of an object higher than a second portion of the object.

14. The cargo lift of claim 2, wherein:
each of said side frame pieces includes an upper side rail and a lower side rail positioned parallel to said upper side rail;
said lower side rail is configured to be positioned at an upper edge of a respective one of the side walls of the trailer or pickup truck when said frame is positioned above the bed of the trailer or pickup truck; and
each of said front frame piece and said rear frame piece extends below said lower side rail of each of said side frame pieces to support said bottom frame piece and said platform a distance below said lower side rail of each of said side frame pieces and at a floor of the bed of the trailer or pickup truck when said frame is positioned above the bed of the trailer or pickup truck.

15. The cargo lift of claim 14, wherein said housing of each of said lift assemblies extends from said upper side rail of each of said side frame pieces to a position even with said bottom frame piece.

16. A method of loading large objects into a bed of a trailer or pickup truck, said method comprising the steps of:
providing a cargo lift for trailers and pickup truck beds comprising:
a frame being rectangular, said frame being detachably couplable to anchors in a bed of a trailer or pickup truck, said frame including:
a front frame piece;
a pair of side frame pieces being coupled to and extending perpendicularly from said front frame piece;
a rear frame piece being coupled to and extending perpendicularly between said side frame pieces, said rear frame piece including a U-shaped opening being configured for movement of objects into and out of said frame;
a bottom frame piece being coupled to a lower portion of said front frame piece and a lower portion of said rear frame piece in alignment with said U-shaped opening, said bottom frame piece extending perpendicularly between said front frame piece and said rear frame piece;
a platform being coupled to said bottom frame piece, said platform being configured to support objects thereon; and
four lift assemblies, each of said lift assemblies being coupled to said frame at a respective end of each of said side frame pieces, said lift assemblies being configured to selectively raise and lower said frame and said platform between an elevated position above side walls of the bed of a trailer or pickup truck and a lowered position on a ground surface, each of said lift assemblies being positioned on said frame such that said lift assemblies are configured to extend outside of and parallel to the side walls of the bed of the trailer or pickup truck when said frame is positioned above the bed of the trailer or pickup truck;
moving an object through said U-shaped opening in said rear frame piece and onto said platform;
activating said lift assemblies and elevating said frame and said platform to said elevated position;
driving a trailer or pickup truck in reverse and positioning a bed of the trailer or pickup truck under said frame and between said lift assemblies;
activating said lift assemblies and lowering said frame and said platform until said frame is supported on the trailer or pickup truck and said lift assemblies are suspended from a ground surface; and
detachably securing said frame to anchors of the bed of the trailer or pickup truck.

17. The method of claim 16, wherein:
each of said lift assemblies includes:
a housing coupled to said frame;
a leg positioned in said housing in a telescoping manner;
a foot attached to an end of said leg; and
a drive mounted to said housing, said drive is coupled to said leg to selectively extend said leg out of said housing and retract said leg into said housing to selectively raise and lower said frame and said platform;
said step of elevating said frame includes extending said legs out of said housing; and
said step of lowering said frame includes retracting said legs into said housing.
